(19) United States
(12) Patent Application Publication
(10) Pub. No.: US 2026/0033621 A1
(43) Pub. Date: Feb. 5, 2026

(54) APPARATUS AND METHODS FOR ATTACHING TOOLS AND ACCESSORIES TO A USER

(71) Applicant: StealthHunter LLC, Craig, CO (US)

(72) Inventor: Brandon R. DUARTE, Craig, CO (US)

(21) Appl. No.: 18/998,752

(22) PCT Filed: Jul. 25, 2023
(86) PCT No.: PCT/US2023/070921

§ 371 Date: Jan. 27, 2025

Related U.S. Application Data
(60) Provisional application No. 63/391,970, filed on Jul. 25, 2022.

(51) Int. Cl. A45F 5/00; A45F 5/02; F16G 11/10

(52) U.S. Cl. CPC A45F 5/004; A45F 5/021; A45F 5/1575; F16G 11/101; A45F 2005/006

(57) ABSTRACT

Methods and lanyard assemblies for retractably and compressively gripping an object are disclosed. The lanyard assembly includes a housing having a chamber and an aperture, a tether extending from the chamber through the aperture; and a retractor disposed in the housing, the retractor attached to the tether and exerts a tensile force on the tether. The tether includes a first end attached to the retractor and an end portion forming a loop having a variable size configured to be reduced by the tensile force of the retractor on the tether, and the loop is configured to grip the object within the loop.

### FIELD

Apparatus and methods for attaching one or more article to a user by a lanyard assembly.

### BACKGROUND

Various activities involve the user carrying articles on the user to be frequently and quickly accessed. For example, a hunter may carry tools and accessories on the hunter's body during hunting activities. Typically, the hunter will store the article in a pocket on the cloth or in a bag, retrieve the article from the pocket or bag, and deploy the article.

### SUMMARY

A lanyard assembly is provided by attaching one or more objects, such as tools and accessories, to a user enabling rapid access by the user.

In an embodiment, a lanyard assembly for compressively gripping on an object being retractable to a user's body by the lanyard assembly is disclosed. The lanyard assembly includes a housing having a chamber and an aperture, a tether extending from the chamber through the aperture, and a retractor disposed in the housing. The retractor attaches to the tether and exerts a tensile force on the tether. The tether includes a first end attached to the retractor and an end portion forming a loop having a variable size reducible by the tensile force on the retractor, and the loop is configured to grip the object within the loop.

In an embodiment, the tensile force of the retractor transfers to the end portion of the tether such that the retractor urges the loop to reduce in size exerting a compressive force that is configured to grip the object within the loop.

In an embodiment, the tensile force of the retractor is configured to provide a sufficient compressive force over a surface of the object to prevent sliding between the object and the loop.

In an embodiment, the lanyard assembly further includes a tether guide defining a passageway that extends through the tether guide. The tether extends through the passageway such that the tether is selectively slidable through the passageway relative to the tether guide, and a second end of the tether is fixed to the tether guide.

In an embodiment, the tether guide has an outer surface, the tether guide defines a first opening to the passageway and a second opening to the passageway, the second opening is disposed at the outer surface, and the tether guide is configured such that the tether at the first opening is substantially perpendicular to the tether at the second opening.

In an embodiment, the housing includes a first wall and a second wall that is substantially perpendicular to the first wall. The first wall faces a first direction. The second wall faces a second direction that is perpendicular to the first direction. The aperture extends through the first wall. The retractor urges the tether guide into contact with the first wall such that the loop extends from the tether guide in second direction.

In an embodiment, the lanyard assembly is configured such that the loop is positioned such that an object within the loop contacts the second wall when the tether guide contacts the first wall.

In an embodiment, the lanyard assembly further includes a tether guide having a tether lock with a barrel body including a closed end and an opened end; a spring disposed in the closed end in the barrel body; and a cap disposed on the open end biased by the spring moving from an unlocked position towards a locked position, such that at the locked position, the cap pinches the tether between barrel body and the cap, and at the unlocked position, the cap is pushed towards the closed end of the barrel body against the spring, unpinching the tether.

In an embodiment, a method of retractably tethering an object to a user by a tether is disclosed. The method includes expanding the loop to increase in size; while holding the loop at an increased size, inserting the object inside the loop; releasing the loop such that the tensile force reduces the size of the loop; and gripping the object within the loop.

In an embodiment, the method includes that the gripping compressively engages the object within the loop such that the object fixedly attached to the loop by the tensile force.

In an embodiment, a method of retractably tethering an object to a user by a tether is disclosed. The method includes expanding the loop to increase in size; while holding the loop at an increased size, inserting the object inside the loop; releasing the loop such that the tensile force reduces the size of the loop; and gripping the object within the loop, wherein the gripping compressively engages the object within the tether guide such that the object fixedly attached to the tether guide by the tensile force.

In an embodiment, a method of carrying an object by a tether is disclosed. The method includes expanding the loop to increase in size; attaching the object in the loop by an exterior surface of the object; and attaching the housing to the user.

In an embodiment, a method of using an object attached on a tether is disclosed. The method includes expanding the loop to increase in size; attaching the object fixedly in the loop; the retractor pulling the object to a retracted position on the housing; attaching the housing to the user; pulling the object away from the housing; extending the tether against the tensile force; releasing the object by the user; and pulling the object back to the retracted position on the housing by the tensile force.

In an embodiment, the object is a game call, a flashlight, a tool, a knife, a wind indicator, a spotting scope, a can of bear spray, or a mace.

In an embodiment, the loop is fixedly gripped over a cylindrical outer surface of the object by the tensile force.

Accordingly, the lanyard assembly provided herein enables easy and rapid attachment of various objects, such as tools and hunting accessories, to the lanyard assembly. More specifically, a user may attach an object to the lanyard simply by the user pulling on the loop to enlarge it, inserting the object inside the loop, and then releasing the loop such that the tensile force on the tether reduces the size of the loop to capture the object therein. Furthermore, the tensile force on the tether is converted into a compressive force that is exerted by the loop on the object, thereby further securing the object to the tether assembly and the user.

The loop portion of the lanyard assembly enables a user to secure a wide range of objects relative to the user's body. The user can pull the object away from the housing for using of the object, and the object stays securely attached to the tether while the object being used. The user might encounter stressful situation when attempting to use the object. If the user accidentally drops the object when pulling out the object or during use, the lanyard assembly will still attach to the object and automatically cause the object to return to the retracted position at housing instead of falling to the ground where the object could break or become soiled or lost. This benefit of the lanyard assembly may be especially important with certain objects used in critical situations where dropping the object is more likely due to the stressful conditions, and the loss of the object could have life-or-death consequences. The lanyard assembly, having a loop fixedly attached to the object further enables the object being returned to the same retracted position in the same orientation of the object consistently. Accordingly, if slipped or dropped, the user can more quickly grab and deploy the object from the retracted position again for using.

For example, the use of the lanyard assembly to secure a can of bear repellent spray would be beneficial for a hiker or camper because the lanyard assembly would easily secure the can to the user's body without any modifications to the can. The lanyard assembly can keep the bear repellent spray constantly at the retracted position. The user can position the lanyard assembly on the body so that the retracted position is within easy reach and readily accessible. The lanyard assembly would not interfere with the user pulling the can of bear repellent away from the housing and into a position for optimum spraying. The lanyard assembly would prevent the can of bear repellent from being dropped during a bear attack, potentially saving the life of the hiker or camper. Even if the user dropped the can, the lanyard assembly quickly retract the can to the retracted position with the same orientation as the user attached the can such that, the user can quickly grab and can again without looking to ensure the correct orientation of the can.

In one embodiment, the lanyard assembly further includes a tether guide defining a passageway that extends through the tether guide. The tether extends through the passageway such that the tether is selectively slidable through the passageway relative to the tether guide. One end of the tether is mounted to the tether guide to form the loop.

The tether guide may change the direction of travel of the tether such that the portion of the tether that forms the loop is approximately 90 degrees from the portion of the tether extending into the housing. This is an improvement over prior art lanyards because it allows the tether to exit the housing from an aperture on the upper surface of the housing, thereby eliminating unnecessary resistance to a user when drawing the object vertically, such as from the user's belt to the user's face, while also enabling the object to rest against a vertical surface of the housing for easy grasping and secure storage when not in use.

The tether guide may also include a locking mechanism to restrict relative movement of the tether relative to the tether guide, thereby further ensuring that the object remains secured within the loop.

In another embodiment, the tether guide is configured such that the loop completely surrounds an object contained therein, i.e., the loop extends 360 degrees around the object, and no part of the tether guide forms any portion of the loop. Thus, in this embodiment, the tether is able to entirely conform to the shape of the object.

In yet another embodiment, the housing is contained within a pack or an article of clothing.

A corresponding method of using a lanyard assembly is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, cross-sectional side view of a lanyard assembly having a housing and a tether forming a loop.

FIG. 2 is a schematic, top view of the lanyard assembly.

FIG. 3 is a schematic, front view of the lanyard assembly.

FIG. 4 is a schematic, top view of the lanyard assembly with an object being retained within the loop against a surface of the housing.

FIG. 5 is a schematic, front view of the lanyard assembly with the object being retained within the loop against the surface of the housing.

FIG. 6 is a schematic, side view of the lanyard assembly with the object pulled away from the housing to cause the tether to extend.

FIG. 7 is a schematic, side view of the lanyard assembly with an alternative tether guide.

FIG. 8 is a schematic, front view of the lanyard assembly of FIG. 7 with an elastic cord and hook configured to selectively retain an object against a surface of the housing.

FIG. 9 is a schematic, side view of the lanyard assembly of FIG. 1 with a pouch attached to the housing and configured to support the object of FIGS. 4-5.

FIG. 10 is a schematic, side view of the lanyard assembly and pouch of FIG. 9 with the object being supported by the pouch.

FIG. 11 is a schematic, side view of an alternative lanyard assembly having two retractable tethers.

FIG. 12 is a schematic, exploded, top view of an alternative tether guide for use with the lanyard assembly, the alternative tether including a clamping mechanism to selectively and releasably maintain the loop at desired sizes.

FIG. 13 is a schematic, cross-sectional, top view of alternative tether guide of FIG. 12 with the clamping mechanism in an unlocked position such that the size of the loop is adjustable.

FIG. 14 is a schematic, cross-sectional, top view of the alternative tether guide of FIG. 12 with the clamping mechanism in a locked position such that the size of the look is fixed.

FIG. 15A is a schematic, front view of another lanyard assembly according to an alternative embodiment.

FIG. 15B is a schematic perspective view of the tether guide of the lanyard assembly of FIG. 15A.

FIG. 16 is a schematic, perspective view of a tether guide according to an embodiment.

FIG. 17 is a tether guide according to an embodiment.

FIG. 18 is a flow chart of a method of using the lanyard assembly.

Like reference numbers refer to like components throughout the drawings.

### DETAILED DESCRIPTION

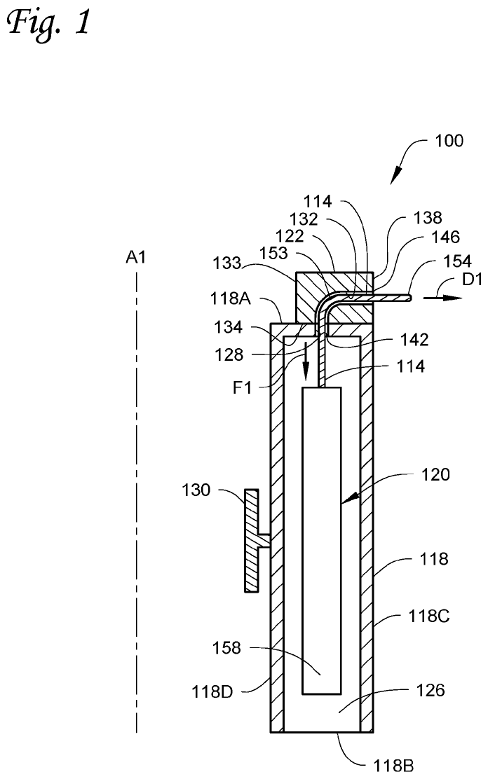

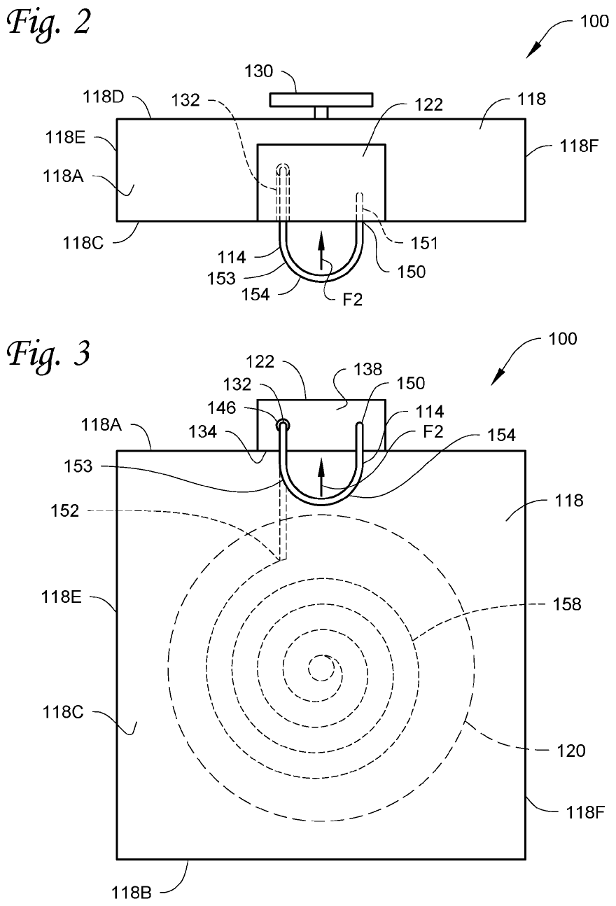

FIGS. 1-6 show an embodiment of a lanyard assembly 100 for compressively gripping on an object to be retractable to a body of a user by the lanyard assembly 100. Dashed lines are used in FIGS. 2, 3, and 4 to show obscured internal features. As shown in FIGS. 1-6, the lanyard assembly 100 includes a tether 114, a housing 118, a retractor 120, and a tether guide 122.

The tether 114 includes an adjustable elongated member and has a first end 151 connected into tether guide 122 and a second end 152 connected to the housing 118. In an embodiment, the second end 152 of the tether 114 connects to the housing 118 via the retractor 120. The tether 114 connects to the retractor 120 at the first end 151 for receiving a tensile force F1. The tether 114 is configured to transfer the tensile force F1 from its first end 151, along the elongated member to an end portion 153 that can be arranged to form a loop 154. In an embodiment, the first end 151 of the tether 114 is included in the end portion 153. It is appreciated that the tether 114 can include a rope, a string, a wire, a strap, a ribbon, or the like, or a combination thereof. In an embodiment, the tether 114 is an adjustable and flexible elongated member.

The housing 118 can be arranged to provide a chamber 126 for components of the lanyard assembly 100 to attach thereon, therein, or the like. In an embodiment, the retractor 120, a middle portion of the tether 114 retracted into the chamber 126, or the like can be disposed in the housing 118, in the chamber 126, or the like.

In the illustrated embodiment, the housing 118 includes a plurality of walls 118A, 118B, 118C, 118D, 118E, and 118F. The walls 118A-F are arranged such that the housing 118 is a rectangular prism. The walls 118A and 118B are parallel to one another; walls 118C and 118D are parallel to one another and perpendicular to walls 118A and 118B; and walls 118E and 118F are parallel to one another and perpendicular to walls 118A, 118B, 118C, and 118D. It is appreciated that the housing 118 is not limited to a rectangular prism. The housing 118 can have any suitable shape that can received a retractor disposed therein. In an embodiment, the housing 118 may have a circular shape, disk shape, shell shape, U-shape, irregular shape, or the like.

A chamber 126 is disposed in the housing 118 for providing a space for the components of the lanyard assembly 100 to disposed therein. In an embodiment, the walls 118A-F are arranged to define the chamber 126 therebetween.

An aperture 128 extends through the housing 118, and the tether 114 is configured to extend through the housing 118 via the aperture 128. In the illustrated example, the aperture 128 extends through the wall 118A of the housing 118. In an embodiment, the aperture 128 extends through the chamber 126 and from an interior to an exterior of the housing 118.

The lanyard assembly 100 may include a clip 130to attach the lanyard assembly 100 to the user's body, e.g., by attaching to an article of clothing or accessories, such as a belt, a strap of a backpack, or the like. In an embodiment, the clip 130 may be attached to the housing 118 of the lanyard assembly (e.g., mounted to the wall 118D of the housing 118).

The tether guide 122 is configured to orientate the tether 114 so that the tether 114 exits the tether guide 122 in a predetermined direction for attaching to an object and/or for being retracted by the retractor 120. In an embodiment, the tether guide 122 includes a passageway 132 extending through the tether guide 122. An exterior surface 133 of the tether guide 122 includes a first planar portion 134 and a second planar portion 138 perpendicular to the first planar portion 134. In an embodiment, the first planar portion 134 may have a shape that corresponds to the upper surface of the wall 118A of the housing 118, such that the first planar portion 134 is received onto the wall 118A and/or mates with the upper surface of the wall 118A. In an embodiment, the tether guide 122 is configured to direct the tether 114 out of the tether guide 122 such that the tether 114 exits the tether guide 122 orientated to extend in a direction D1 that is approximately perpendicular to a vertical axis A1 of a torso of the user wearing the lanyard assembly 100.

The passageway 132 includes a first opening 142 at the first planar portion 134 and a second opening 146 in the second planar portion 138. The passageway 132 extends from the first opening 142 to the second opening 146. The tether 114 extends from the chamber 126 of the housing 118 through the aperture 128, through the opening 142, through the passageway 132, and through opening 146. Thus, the tether guide 122 causes the portion of the tether 114 that is within the passageway 132 to bend approximately ninety degrees. In an embodiment, the tether guide 122 can be configured to bend the tether by 85 to 95 degrees, 80 to 100 degrees, or the like. Accordingly, the portion of the tether 114 that is at the first opening 142 is substantially perpendicular to the portion of the tether 114 that is at the second opening 146. In an embodiment, the passageway 132 is configured to orientate the tether 114 such that the portion of the tether in the chamber 126 is perpendicular to the direction of the tether 114 exiting the tether guide 122.

Referring to FIG. 2, the first end 151 of the tether 114 couples with the tether guide 122 adjacent the opening 146 (shown in FIG. 3), such that a variable segment of the end portion 153 of the tether 114 extends between the opening 146 and the first end 151 defines a loop 154. In an embodiment, the first end 151 is fixedly attached to the tether guide 122. In another embodiment, the first end 151 can be configured to include a stopper (e.g., a knot) to prevent the first end 151 passing through an opening (e.g., opening 150 in the tether guide 122) so that the tether 114 remains connected to the tether guide 122.

The retractor 120 is attached to the housing 118 and is configured to provide a tensile force F1 that retracts a portion of the tether 114 into the housing 118. In the illustrated embodiment, the retractor 120 is disposed in the housing 118 (e.g., see FIG. 1). The retractor 120 exerts a tensile force F1 on the tether 114 that urges the tether 114 to retract through the aperture 128 and into the housing 118. For example, as shown in the illustrated embodiment, the retractor 120 may include a spring-loaded reel 158 (shown in FIG. 3) on which the tether 114 is wound. In such an embodiment, the second end 152 of the tether 114 is connected to the spring-loaded reel 158. It should be appreciated that the retractor 120 may be a different structure than a spring-loaded reel 158, such as a spring, an elastic member, and/or the like, that can provide(s) a tensile force F1 to the tether 114 and retract the tether 114 into the housing 118 while allowing a user to exert a force to overcome the tensile force F1 to extend the tether 114 out of the housing 118.

The aperture 128 and the passageway 132 are sized according to the size and shape of the tether 114. In an embodiment, the aperture 128 and the passageway 132 are configured not to resist movement of at least a middle portion of the tether 114 therethrough. For example, the middle portion may be a portion of the tether 114 extendable and retractable when the user pulls on the object or the tether guide 122. The tether 114 is slidable through the aperture 128 and the passageway 132 and therefore slidable relative to the housing 118 and the tether guide 122. The force F1 of the retractor 120 on the tether 114 urges the tether 114 to retract through the aperture 128 in the tether guide 122 and the passageway 132, thereby urging the loop 154 to shrink in size, and thereby causing the loop 154 to exert a radially-inward force F2 on the object disposed therein and against the tether guide 112.

For example, the force F2 is a compressive force that grips an object 162 within the loop 154. The object 162 may be fixedly gripped relative to the loop 154 such that, when a user pulls the tether guide 122 (or the object 162) away from the housing 118, the object 162 remains attached/gripped in the loop 154 and to the tether guide 122. It is appreciated that, when the loop 154 fixedly grips onto the object 162, the compressive force (e.g., radially-inward force F2) is applied to the surface of the object 162 such that the object 162 and the loop 154 do not slip or slide relative to each other. In an embodiment, the loop 154 and a spacing between the opening 146 and the opening 150 are configured such that, when the loop 154 is attached to the object, the loop is exerting force along at least ½, at least ⅔, at least ¾, at least ⅞, or 100% of the entire radius of the object being held therein. In an embodiment, when the loop 154 is attached to the object, the loop is in contact with at least ½, at least ⅔, at least ¾, at least ⅞ or 100% of the entire radius of the object being held therein.

FIGS. 1-3 depict the lanyard assembly 100 in a first configuration, i.e., without an external force (e.g., a user pulling force) acting on the tether 114, except for gravity. It should be appreciated that the loop 154 is illustrated to slightly extend out from the tether guide 122 in FIGS. 1-3 to illustrate the structure of the loop 154. In an embodiment, without a user's pulling force, the tensile force F1 reduces the size of the loop 154 such that the loop 154 is wrapped on (e.g., is in contact with) the tether guide 122. For example, the tensile force F1 is transferred from the tether 114 to the tether guide 122. The tensile force F1 pulls the loop 154 to reduce the size and the loop 154 closely wraps on, and in contact with, the tether guide 122 over the surface of the tether guide 122 between the opening 146 and the opening 150. The tensile force F1 pulls the first planar portion 134 of the tether guide 122 against the wall 118A of the housing 118 such that the first opening 142 to the passageway 132 is aligned with the aperture 128.

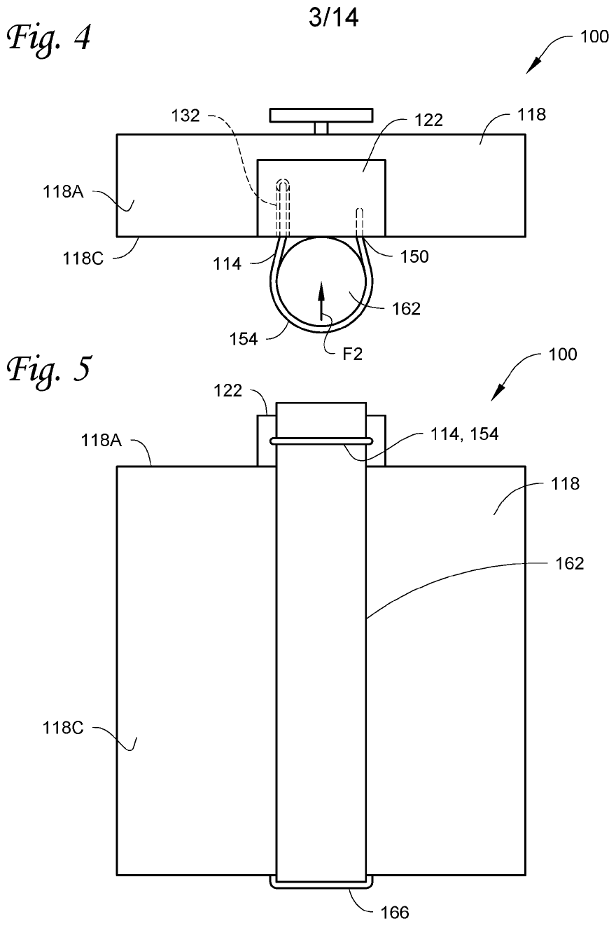

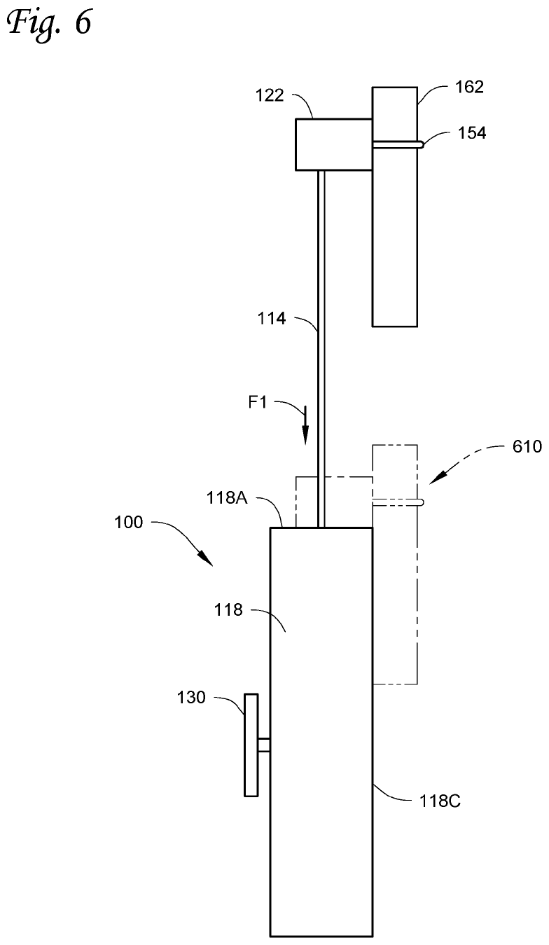

FIGS. 4-6 show the lanyard assembly 100 with an object 162 operatively connected to an object 162. FIGS. 5 and 6 show the lanyard assembly 100 in a retracted position. FIG. 6 shows the lanyard assembly 100 in an extended positon (in solid lines) and in a retracted positon 610 (in dashed lines).

The radially-inward force F2 is employed to secure the object 162 in the loop 154. To attach the object 162 to the lanyard assembly 100, a user pulls on the loop 154 (e.g., outwards, away from the tether guide 122, away from the second planar portion 138 of the tether guide 122) to overcome the bias of the retractor 120 and draw more of the tether 114 out of the housing 118 and through the passageway 132 in the tether guide 122. More of the tether 114 extends from the tether guide 122 through the opening 146 thereby increasing the size of the loop 154. Once the loop 154 is large enough such that the object 162 can fit therein, the user can insert the object 162 in the loop 154. Then, the user releases the loop 154, and the tensile force from the retractor 120 draws the tether 114 back into the housing 118, thereby reducing the size of the loop 154 and causing the loop 154 to exert the force F2 on the object 162. The loop 154 presses the object 162 against the tether guide 122 (e.g., the object 162 is squeezed between the loop 154 and the tether guide 122). It is appreciated that the retractor 120 is configured to simultaneously exert both force F1 and F2 to retract the tether 114 and securely attach and position the object 162 to a retracted position 610 (shown in FIG. 6) relative to the housing 118.

In the illustrated embodiment, the tether guide 122 is configured such that, when the first planar portion 134 abuts the wall 118A, the loop 154 is positioned such that the object 162 within the loop 154 abuts wall 118C of the housing 118. It is appreciated that, when the clip 130 is attached to the user's belt or waistband, the wall 118A faces upward and forms the top of the housing 118, and the wall 118C is vertically oriented. Thus, the placement and orientation of the object 162 against the wall 118C places the object 162 in a desirable position where it can be readily grasped for use. The loop 154 tightly wraps around the object 162 such that, when the user releases the object 162, the object 162 returns to the same retracted position 610 (shown in FIG. 6) and facing the same direction constantly. In an embodiment, the lanyard assembly 100 may include a support 166 (shown in FIG. 5) to support the lower end of the object 162.

FIG. 6 is a schematic, side view of the lanyard assembly 100 with the object pulled away from the housing 118 to cause the tether 114 to extend.

As shown in FIG. 6, the tether guide 122 is movable with respect to the housing 118. By overcoming the force F1 to permit more of the tether 114 to exit the housing 118, a user may draw the object 162 away from the housing 118 while the object 162 is still secured by the loop 154 (e.g., while the object remains pressed against the tether guide 122 by the loop 154). In an embodiment, the tether guide 122 moves with the object 162 away from the housing 118, thereby maintaining the object 162 within the loop 154. When the assembly 100 is mounted to a user's belt or other article of clothing, the user draws the object 162 upward and away from the housing 118 to use the object 162. When the user is done with the object 162, the user may release the object 162 and the retractor 120 will automatically return the object 162 back into the retracted position 610. In an embodiment, the retracted position 610 is a position against the housing 118, as also shown in FIGS. 4 and 5. It is appreciated that that the lanyard assembly 100 can be mounted or clipped to cloth or accessories other than belts or articles of clothing. For example, lanyard assembly 100 may be attached or clipped to a strap, a backpack, other accessory packs, pouches, or the like.

It is appreciated that, the lanyard assembly 100 secures an object 162 near a user's body while the object 162 remains securely attached to the lanyard assembly 100 when the user moves the object 162 away from the housing 118 for use. The user may move the object 162 for use, and the lanyard assembly 100 will automatically return the object 162 against the user's body once released by the user. The loop 154 being acted upon by the retractor 120 enables a user to attach to the lanyard assembly 100 any object 162 that will fit within the loop 154, regardless of the size or shape of the object 162, and without requiring corresponding attachment features (e.g., a hole for receiving a strap or a smaller grip portion that is smaller than the rest of the body, or the like) on the object 162. Example objects that may be used secured within the loop include, without limitation, a game call (e.g., a turkey call, a bird call, a coyote call, or the like), a flashlight, a tool, a knife, a wind indicator, a spotting scope, a can of bear spray, a mace, or the like. In an embodiment, a cylindrical portion on an outer surface of the object 162 can be suitable for being gripped by the loop 154 and attached to the lanyard assembly 100.

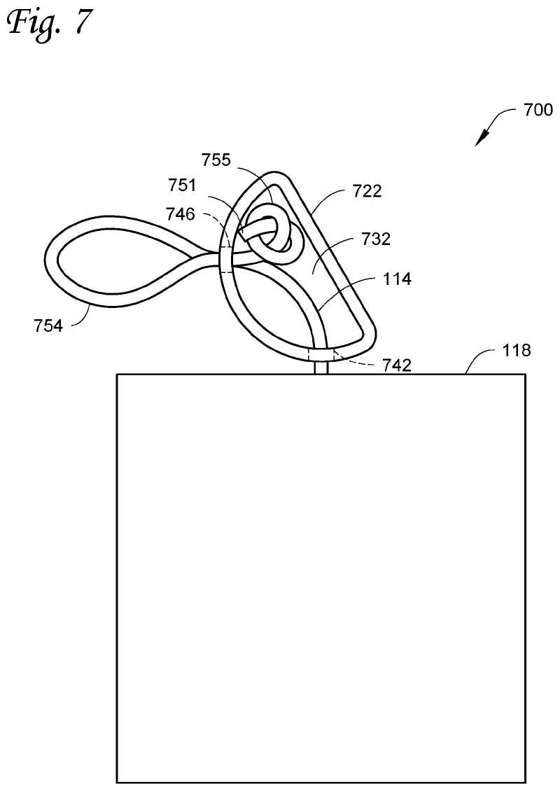

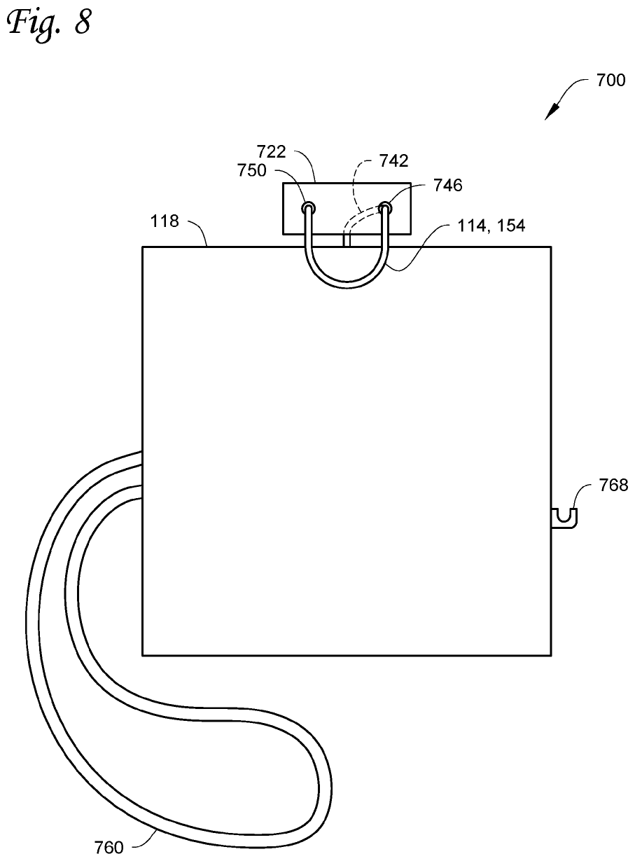

FIGS. 7 and 8 schematically depict another embodiment of a lanyard assembly 700. Lanyard assembly 700 can be similar to the lanyard assembly 100 of FIG. 1 with a tether guide 722 is used in place of, or in addition to, the tether guide 122 of FIG. 1.

The tether guide 722 defines a semi-cylindrical bracket that defines openings 742, 746 to the passageway 732. Openings 742 and 746 are oriented such that, at the locations of the tether 114 extending from the openings 742 and 746, the tether 114 is bent approximately 90 degrees. The tether guide 722 includes an opening 750 (shown in FIG. 8) to the passageway 732. The tether 114 extends from opening 746 back into the passageway 732 through the opening 750. A variable segment of the tether 114 between the openings 746 and 750forms a loop 754. The end 751 of the tether 114 forms a knot 755 that obstructs the end 751 from passing back out of the opening 746 under the tensile force of the retractor (not shown), thereby attaching the end 751 to tether guide 722. It is appreciated that the openings 742 and 746 is not required to be discrete or separated openings such that the opening 742 and 746 may be included in a connected opening.

As shown in FIG. 8, in an embodiment, the lanyard assembly 700 may include an optional strap 760 configured to further secure the object against the housing 118. In an embodiment, the strap 760 can be an elastic belt, cord, or loop that is attached to one wall of the housing 118. A hook 768 is attached to the housing 118 and configured to be engaged with the strap 760, with the housing 118 partially wrap around an object 162 to further secure the object against the housing 118.

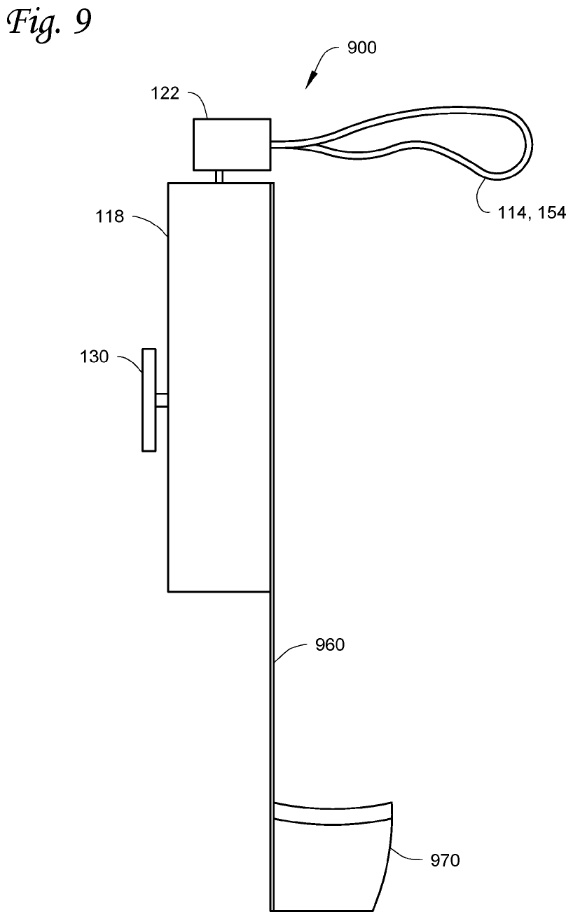

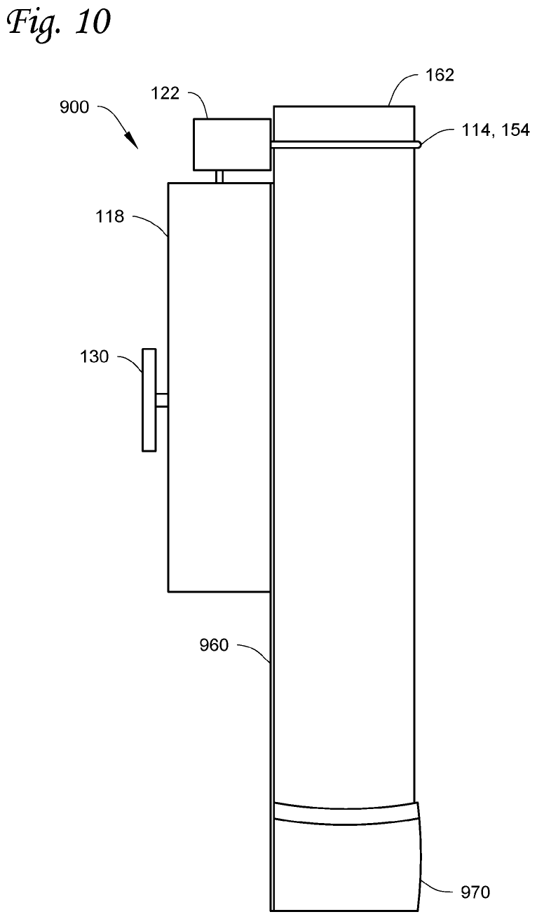

FIGS. 9 and 10 schematically show another embodiment of a lanyard assembly 900. In the illustrated embodiment, the lanyard assembly 900 can have similar features to the lanyard assembly 100 in FIGS. 1-6, except as discussed below. In a different embodiment, the lanyard assembly 900 may include features similar to the lanyard assembly 700 in FIGS. 7-8.

As shown in FIG. 9, The lanyard assembly 900 includes a pouch 970 mounted with respect to the housing 118. The pouch 970 is positioned below the housing 118 to accept and support an object 162 within the loop 154.

As shown in FIG. 9, the lanyard assembly 900 includes the pouch 970 to vertically support the object 162 (shown in FIG. 8) in the retracted position. The pouch 970 can be configured to be expandable (e.g., by elastic lip, cord, or the like) such that the object 162 can be securely positioned in the pouch 970. In an embodiment, the pouch 970 is attached below the housing 118 of the lanyard assembly 900 by an extender 960.FIG. 10 shows the object 162 secured in the lanyard assembly 900.

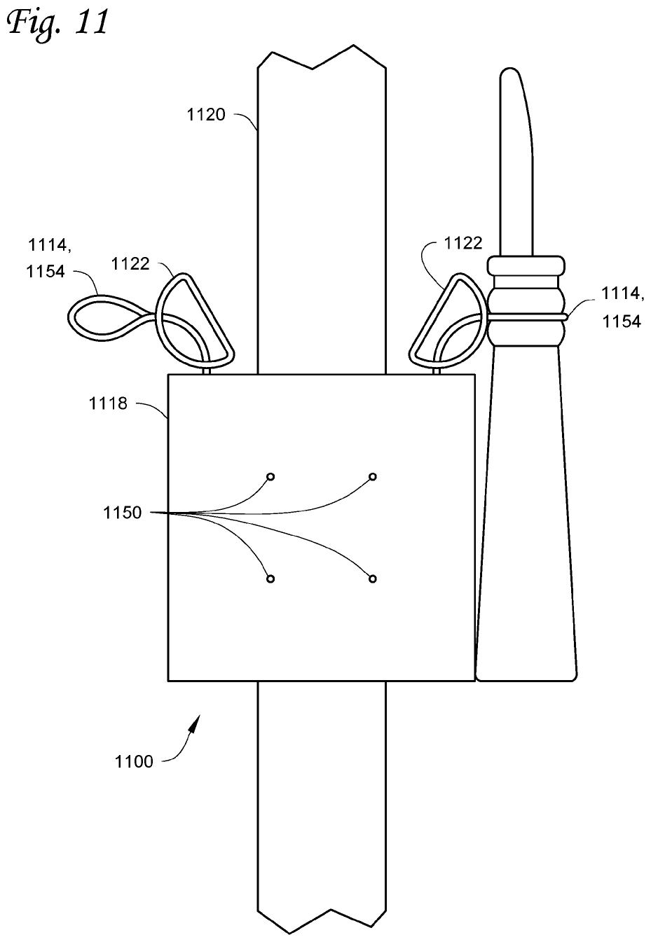

FIG. 11 schematically shows another embodiment of a lanyard assembly 1100 having a housing 1118 with two tethers 1114, two tether guides 1122, and two loops 1154 that may operate in the similar manner as described with respect to the embodiment(s) of FIGS. 1-10. It is appreciated that each of the loops 1154 may be configured to attach to an object 162.

As shown in FIG. 11, a housing 1118 of a lanyard assembly 1100 is attached to a strap 1120. The strap 1120 can be a shoulder strap of a backpack, a strap on a carrying harness, and/or any other accessories that includes a strap. In an embodiment, the lanyard assembly 1100 may include a clip (e.g., clip 130 of FIG. 1) for attaching the lanyard assembly 1100 to the strap 1120. In an embodiment, the lanyard assembly 1100 includes one or more mounting holes 1150 to each respectively receives one or more fasteners to attached the lanyard assembly 1100 to the strap, a cloth article, or other accessories worn by the user.

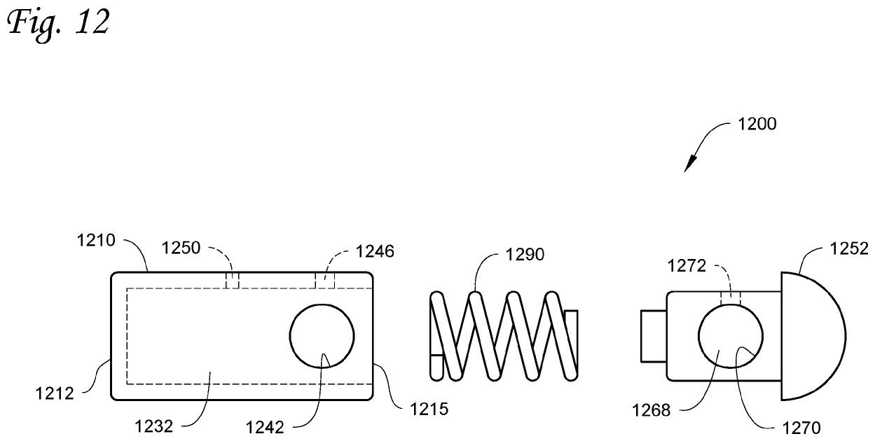

FIGS. 12-14 schematically show a tether guide 1200 according to an embodiment. Dashed lines are provided in FIG. 12 to show obscured features. The tether guide 1200 can be another embodiment of the tether guide 122, 722, 1122, or the like as shown and described above.

The tether guide 1200 includes a tether lock 1260 that selectively prevents the tether 114 from sliding through the passageway formed by the tether guide 1200, thereby maintaining the loop 154 at a constant size.

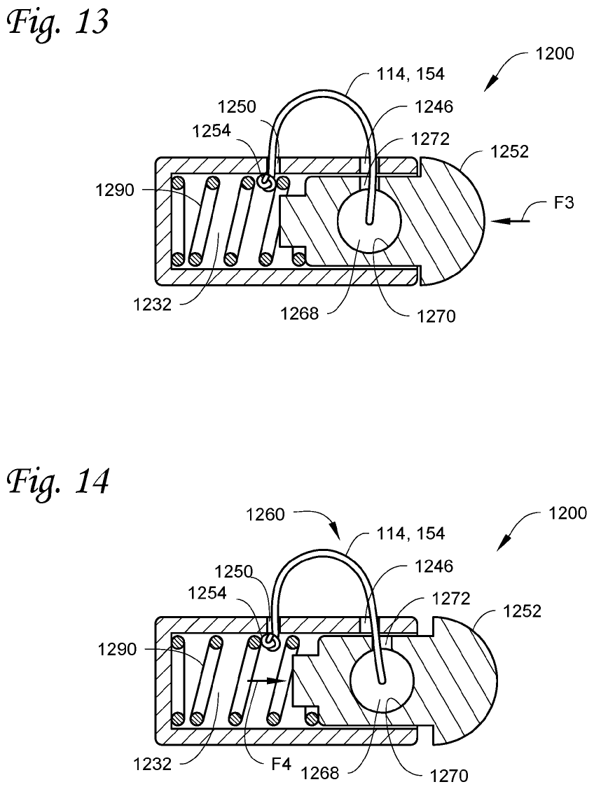

The tether lock 1260 includes a barrel 1210, a cap 1252 and a spring 1290. In an embodiment, the barrel 1210 defines a cylindrical cavity that functions as a passageway 1232 for the tether 114. The cap 1252 can be generally cylindrical and is partially inserted into the passageway 1232 such that the cap 1252 is translatable between an unlocked position (shown in FIG. 13) and a locked position (shown in FIG. 14).

The spring 1290 is disposed in the closed end 1212 inside the barrel 1210. The cap 1252 is positioned over an open end 1215 of the barrel 1210. The spring 1290 is disposed to be biased towards the open end 1215. In an embodiment, the spring 1290 may be tapered or otherwise shaped such that a stopper or knot (e.g., in the barrel 1210 behind the opening 1250) does not interfere with the movement of the spring 1290.

In the locked position, the cap 1252 is configured to pinch the tether 114 between the cap 1255 and the barrel 1210 to prevent or restrict the tether 114 from sliding relative to the tether guide 1200 when the cap 1252 is in the locked position. The cap 1252 unpinches or releases the tether 114 in the locked position. In an embodiment, the cap 1252 and the barrel 1210 do not limit or restrict the sliding of the tether 114 relative to the tether guide 1200 when the cap 1252 is in the unlocked position.

It is appreciated that the tether guide 1200 defines first and second openings 1242, 1246 that extend from the outer surface of the tether guide 1200 to the passageway 1232. The tether 114 extends through openings 1242 and 1246 in a similar manner as the tether 114 extends through opening 142, 146 (shown in FIGS. 1-6). An opening 1250 functions in a similar manner as the opening 750 in FIGS. 7 and 8, e.g., to receive a knot 1254 that prevented the tether from exiting through the opening 1250.

The tether guide 1200 defines a passageway 1232. The tether 114 extends through the passageway 1232. The passageway 1268 bends the tether 114 ninety-degrees between the opening 1270 and the opening 1272.

When a user asserts a force F3 (shown in FIG. 13), the cap 1252 overcomes the spring force F4 (shown in FIG. 14) and moves towards the left (as orientated on FIG. 13) to an unlocked position. When the tether guide 1200 is in the unlocked position (shown in FIG. 13), the opening 1246 is aligned with opening 1272. When the opening 1246 is aligned with opening 1272, the tether 114 is unpinched and released by a passageway 1232 and unhindered from sliding through passageway 1232.

When the user releases the force F3, the spring 1290 pushes the cap 1252 to the right (as orientated on FIG. 14) to pinch the tether 114 between the barrel 1210 and the cap 1252. In the locked position, as shown in FIG. 14, the opening 1246 is offset with opening 1242, and thus the tether 114 is clamped or pinched between the barrel 1210 and the cap 1252. In such embodiment, the loop 154 may remain a constant size unless a user exerts a force F3 on the end of the tether guide 1200 to overcome the bias of the spring 1290 and moves the cap 1252 to the unlocked position. In such embodiment, with an object disposed in the loop 154, the tether lock may provide an additional security, or a backup mechanism, to the tensile force asserted by the retractor to securely attach the object 162 in the loop 154.

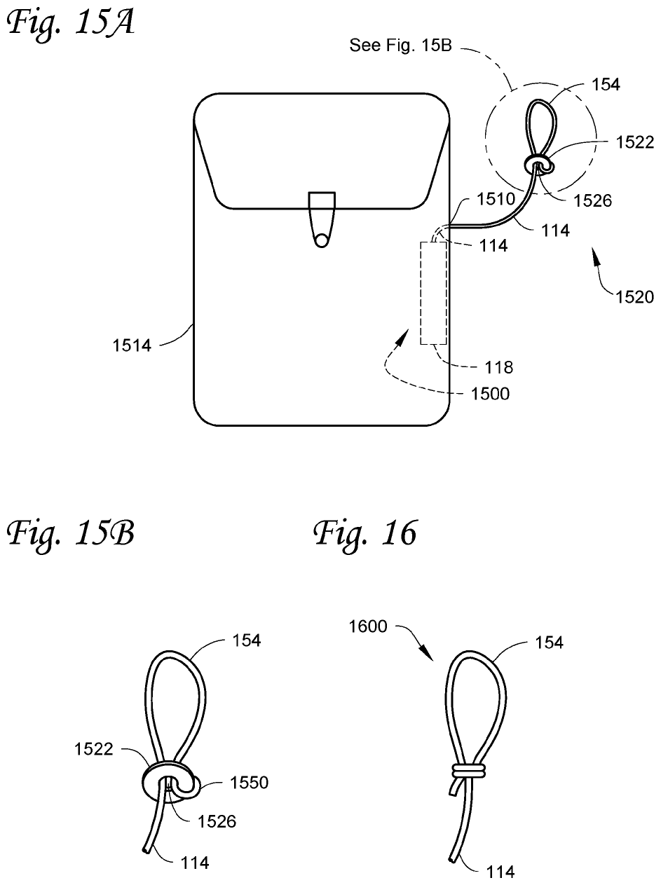

FIGS. 15A and 15B schematically shows a lanyard assembly 1500 having a housing 118, a tether guide 1520, and a tether 114 that extends from the housing 118. The lanyard assembly 1500 is acted upon by a retractor (not shown) in the housing 118 such that the tether 114 behaves in a similar manner as shown and described, e.g., in FIG. 1. In an embodiment, the housing 118 is sewn, installed, or clipped into a wall or liner of a pack 1514. The pack 1514 defines a hole 1510 through which the tether 114 extends such that the tether 114 bends approximately 90 degrees between exiting the housing 118 and extending from the hole 1510 in the pack 1514. In an embodiment, when the loop 154 is attached to the object, the loop is in contact with at least ⅞ of the entire radius of the object being held therein.

The pack 1514, the hole 1510, and the annulus 1522 provides a tether guide. The annulus 1522 includes a central aperture 1526. The tether 114 extends through the central aperture 1526 and is routed back through the central aperture 1526 to form the loop 154. The end 1550 is tied around the annulus 1522.

FIG. 16 schematically depicts an embodiment in which a slip knot 1600 is formed in the tether 114 to form the loop 154, thereby eliminating the need for a separate annulus 1522 in the tether guide. In an embodiment, when the loop 154 is attached to the object, the loop is in contact with 100% of the entire radius of the object being held therein.

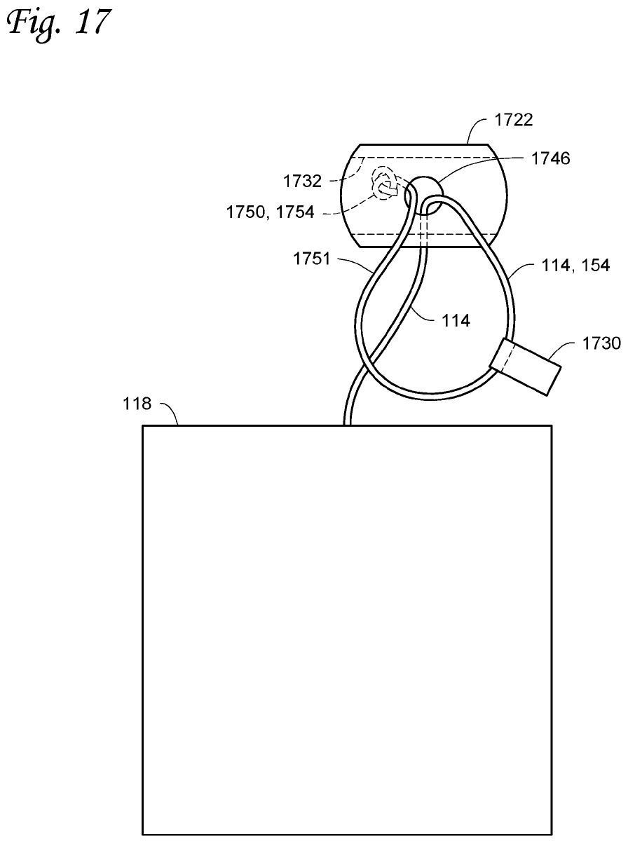

FIG. 17 schematically depicts a tether guide 1722 in which the end 1750 of the tether 114 is routed back into the passageway 1732 through the same opening 1746 through which the tether 114 exits the passageway 1732, i.e., the tether 114 passes through the opening 1746 twice to form the loop 154. The end 1750 forms an enlarged knot 1754 to prevent the end 1750 passing through the opening 1746. In such embodiment, the loop 154 may be entirely formed by the tether 114 and the tether 114 may completely surround an object within the loop 154. In an embodiment, the end 1750 is included in an end portion 1751. A tag 1730 or other object larger than the opening 1746 is attached to the loop 154 to prevent the tether from completely retracting through the opening 1746.

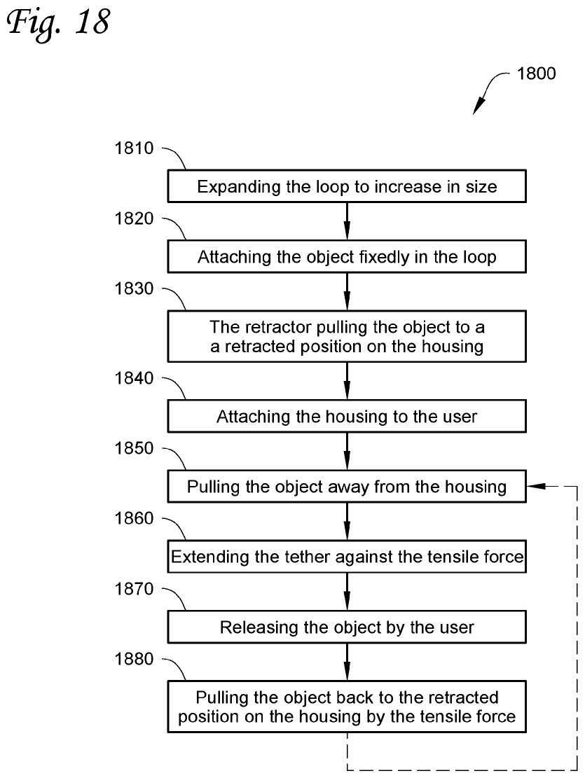

FIG. 18 is a flow chart showing a method of using the lanyard assembly as shown and described above according to some embodiments. The method 1800 includes attaching an object to a lanyard assembly as shown and described above and the user and using an object attached on the tether of the lanyard assembly.

The method 1800 starts at 1810. At 1810, the method includes expanding the loop to increase in size. The user can be expanding the loop by pulling the loop outwardly from the housing of the lanyard assembly so that the loop is enlarged to fit over an exterior surface of the object. Then, the method 1800 proceeds to 1820.

At 1820, the user attaches the object fixedly in the loop. For example, the user can place the object in the enlarged loop and release the tether. Once the user releases the tether, the tensile force from the retractor urges the loop to reduce in size and attaches to the object by tightly wrapping around the object. Then, the method 1800 proceeds to 1830.

At 1830, the retractor pulls the object to a retracted position on the housing. In an embodiment, the retractor pulls the object by a tensile force transferred by the tether towards inside of the housing of the lanyard assembly. Then, the method 1800 proceeds to 1840. It is appreciated that, 1840 can occur in any order and/or concurrent with 1810, 1820, and 1830 such that, when 1840 occurs before 1830, the method 1800 proceeds to 1850

At 1840, the user attaches the housing to the user, for example, by a clip or fastener disposed on the housing of the lanyard assembly. In an embodiment, the user attaches the housing by wearing a pack (shown in FIG. 15A). Then, the method 1800 proceeds to 1850.

At 1850, the user pulls the object away from the housing, e.g., for using the object. For example, the object can be a game call (e.g., a turkey call, a coyote call, or the like), the user can pull the game call away from the housing towards the user's mouth for blowing into the game call. For another example, the object can be a can of pepper spray, and the user can pull the can of pepper spray up and forward to aim at the target. It is appreciated that, the tether guide being fixed attached to the object by the loop and the tensile force by the retractor, the user may pull the object by holding onto the object itself and/or holding and pulling by the tether guide. Then, the method 1800 proceeds to 1860.

At 1860, when the user pulls on the object away from the housing, the user extends the tether against the tensile force, e.g., exerted by the retractor, pulling a larger portion of the tether outside of the housing so that the user can have a larger room for movement while holding the object tethered to the lanyard assembly. Then, the method 1800 proceeds to 1870.

At 1870, the user releases the object. It is appreciated that the user may release the object accidentally or intentionally. For example, the user may be nervous and/or having slippery hands from gloves, sweat, mud or water, and accidentally drops the object. The user may intentionally release the object after the user is done using the object. Then, the method 1800 proceeds to 1880.

At 1880, the retractor pulls the object back to the retracted position on the housing by the tensile force. The object will stay at the retracted position on the housing by the tensile force until the user pulls the object again, e.g., at 1850.

Aspects:
Aspect 1. A lanyard assembly for retractably and compressively gripping an object, the lanyard assembly comprising:
   a housing having a chamber and an aperture;
   a tether extending from the chamber through the aperture; and
   a retractor disposed in the housing, the retractor attached to the tether and exerts a tensile force on the tether,
   wherein the tether includes a first end attached to the retractor and an end portion forming a loop having a variable size configured to be reduced by the tensile force of the retractor on the tether, and the loop is configured to grip the object within the loop.
Aspect 2. The lanyard assembly of aspect 1, wherein the tensile force of the retractor transfers to the end portion of the tether such that the retractor urges the loop to reduce in size. exerting a compressive force that is configured to grip the object within the loop.
Aspect 3. The lanyard assembly of aspect 1 or 2, wherein the tensile force of the retractor is configured to provide a sufficient compressive force over a surface of the object to prevent sliding between the object and the loop.
Aspect 4. The lanyard assembly of any one of aspect 1-3, further comprising
   a tether guide defining a passageway that extends through the tether guide, wherein
   the tether extends through the passageway such that the tether is selectively slidable through the passageway relative to the tether guide, and
   a second end of the tether is fixed to the tether guide.
Aspect 5. The lanyard assembly of aspect 4, wherein
   the tether guide has an outer surface,
   the tether guide defines a first opening to the passageway and a second opening to the passageway,
   the second opening is disposed at the outer surface, and
   the tether guide is configured such that the tether at the first opening is substantially perpendicular to the tether at the second opening.
Aspect 6. The lanyard assembly of any one of aspects 4-5, wherein the housing includes a first wall and a second wall that is substantially perpendicular to the first wall;
   wherein the first wall faces a first direction;
   wherein the second wall faces a second direction that is perpendicular to the first direction;
   wherein the aperture extends through the first wall; and
   wherein the retractor urges the tether guide into contact with the first wall such that the loop extends from the tether guide in second direction.
Aspect 7. The lanyard assembly of aspect 6, wherein the lanyard assembly is configured such that the loop is positioned such that an object within the loop contacts the second wall when the tether guide contacts the first wall.
Aspect 8. The lanyard assembly of any one of aspects 1-7, further comprising:
   a tether guide having a tether lock with a barrel body including a closed end and an opened end;
   a spring disposed in the closed end in the barrel body; and
   a cap disposed on the open end biased by the spring moving from an unlocked position towards a locked position, such that
   at the locked position, the cap pinches the tether between barrel body and the cap, and
   at the unlocked position, the cap is pushed towards the closed end of the barrel body against the spring, unpinching the tether.
Aspect 9. A method of retractably tethering an object to a user by a tether according to any one of aspects 1-8, comprising:
   expanding the loop to increase in size;
   while holding the loop at an increased size, inserting the object inside the loop;
   releasing the loop such that the tensile force reduces the size of the loop; and
   gripping the object within the loop.
Aspect 10. The method of aspect 9 further, wherein:
   the gripping compressively engages the object within the loop such that the object fixedly attached to the loop by the tensile force.
Aspect 11. A method of retractably tethering an object to a user by a tether according to any one of aspects 4-8, comprising:
   expanding the loop to increase in size;
   while holding the loop at an increased size, inserting the object inside the loop;
   releasing the loop such that the tensile force reduces the size of the loop; and
   gripping the object within the loop, wherein
   the gripping compressively engages the object within the tether guide such that the object fixedly attached to the tether guide by the tensile force.
Aspect 12. A method of carrying an object by a tether according to any one of aspects 1-8, comprising:
   expanding the loop to increase in size;
   attaching the object in the loop by an exterior surface of the object; and
   attaching the housing to the user.
Aspect 13. A method of using an object attached on a tether according to any one of aspects 1-8, comprising:
   expanding the loop to increase in size;
   attaching the object fixedly in the loop;
   the retractor pulling the object to a retracted position on the housing;
   attaching the housing to the user;
   pulling the object away from the housing;
   extending the tether against the tensile force;
   releasing the object by the user; and
   pulling the object back to the retracted position on the housing by the tensile force.
Aspect 14. The method of one aspects of 11-13, wherein
   the object is a game call, a turkey call, a bird call, a coyote call, a flashlight, a tool, a knife, a wind indicator, a spotting scope, a can of bear spray, or a mace.
Aspect 15. The method of any one aspects of 11-14, wherein the loop is fixedly gripped over a cylindrical outer surface of the object by the tensile force.

The terminology used in this Specification is intended to describe particular embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This Specification and the embodiments described are exemplary only, with the true scope and spirit of the disclosure being indicated by the claims that follow.

1. A lanyard assembly for retractably and compressively gripping an object, the lanyard assembly comprising:
a housing having a chamber and an aperture;
a tether extending from the chamber through the aperture; and
a retractor disposed in the housing, the retractor attached to the tether and exerts a tensile force on the tether,
wherein the tether includes a first end attached to the retractor and an end portion forming a loop having a variable size configured to be reduced by the tensile force of the retractor on the tether, and the loop is configured to grip the object within the loop.

2. The lanyard assembly of claim 1, wherein the tensile force of the retractor transfers to the end portion of the tether such that the retractor urges the loop to reduce in size. exerting a compressive force that is configured to grip the object within the loop.

3. The lanyard assembly of claim 1, wherein the tensile force of the retractor is configured to provide a sufficient compressive force over a surface of the object to prevent sliding between the object and the loop.

4. The lanyard assembly of claim 1, further comprising
a tether guide defining a passageway that extends through the tether guide, wherein
the tether extends through the passageway such that the tether is selectively slidable through the passageway relative to the tether guide, and
a second end of the tether is fixed to the tether guide.

5. The lanyard assembly of claim 4, wherein
the tether guide has an outer surface,
the tether guide defines a first opening to the passageway and a second opening to the passageway,
the second opening is disposed at the outer surface, and
the tether guide is configured such that the tether at the first opening is substantially perpendicular to the tether at the second opening.

6. The lanyard assembly of claim 4, wherein the housing includes a first wall and a second wall that is substantially perpendicular to the first wall;
wherein the first wall faces a first direction;
wherein the second wall faces a second direction that is perpendicular to the first direction;
wherein the aperture extends through the first wall; and
wherein the retractor urges the tether guide into contact with the first wall such that the loop extends from the tether guide in second direction.

7. The lanyard assembly of claim 6, wherein the lanyard assembly is configured such that the loop is positioned such that an object within the loop contacts the second wall when the tether guide contacts the first wall.

8. The lanyard assembly of claim 1, further comprising:
a tether guide having a tether lock with a barrel body including a closed end and an opened end;
a spring disposed in the closed end in the barrel body; and
a cap disposed on the open end biased by the spring moving from an unlocked position towards a locked position, such that
at the locked position, the cap pinches the tether between barrel body and the cap, and
at the unlocked position, the cap is pushed towards the closed end of the barrel body against the spring, unpinching the tether.

9. A method of retractably tethering an object to a user by a tether according to claim 1, comprising:
expanding the loop to increase in size;
while holding the loop at an increased size, inserting the object inside the loop;
releasing the loop such that the tensile force reduces the size of the loop; and
gripping the object within the loop.

10. The method of claim 9 further, wherein:
the gripping compressively engages the object within the loop such that the object fixedly attached to the loop by the tensile force.

11. A method of retractably tethering an object to a user by a tether according to claim 4, comprising:
expanding the loop to increase in size;
while holding the loop at an increased size, inserting the object inside the loop;
releasing the loop such that the tensile force reduces the size of the loop; and
gripping the object within the loop, wherein the gripping compressively engages the object within the tether guide such that the object fixedly attached to the tether guide by the tensile force.

12. A method of carrying an object by a tether according to claim 1, comprising:
expanding the loop to increase in size;
attaching the object in the loop by an exterior surface of the object; and
attaching the housing to the user.

13. A method of using an object attached on a tether according to claim 1, comprising:
expanding the loop to increase in size;
attaching the object fixedly in the loop;
the retractor pulling the object to a retracted position on the housing;
attaching the housing to the user;
pulling the object away from the housing;
extending the tether against the tensile force;
releasing the object by the user; and
pulling the object back to the retracted position on the housing by the tensile force.

14. The method of claim 11, wherein
the object is a game call, a turkey call, a bird call, a coyote call, a flashlight, a tool, a knife, a wind indicator, a spotting scope, a can of bear spray, or a mace.

15. The method of claim 11, wherein the loop is fixedly gripped over a cylindrical outer surface of the object by the tensile force.
